(19) United States
(12) Patent Application Publication
(10) Pub. No.: US 2017/0031950 A1
(43) Pub. Date: Feb. 2, 2017

(54) COMMUNICATION BASED SEARCHING METHOD AND APPARATUS

(71) Applicant: Lennar Pacific Properties Management, Inc., Miami, FL (US)

(72) Inventors: Laura Lete, St. Augustine, FL (US); Stephen Smith, Miami, FL (US); Christopher Oakes, Miami, FL (US)

(21) Appl. No.: 15/221,232

(22) Filed: Jul. 27, 2016

Related U.S. Application Data
(60) Provisional application No. 62/197,440, filed on Jul. 27, 2015.

(51) Int. Cl. G06F 17/30

(52) U.S. Cl. CPC G06F 17/30241; G06F 17/3087; G06F 17/30675; G06F 17/30867; G06F 17/30696

(57) ABSTRACT

A system for storing and accessing data relating to real estate, for example, a memory or a software application for execution upon an electronic device (e.g., smartphone). The software application provides to the user information, statistics, or other data regarding real estate or associated geographic regions based upon user criteria. The software application may access a memory, for example, a remote memory or database having structured or unstructured data. Communication recognition (e.g., voice, text, etc.) utilizes context to provide appropriate results based upon user input. Information may regard not only specific details of a real estate property, but also surrounding geography or municipality data. Image recognition features may also allow users to obtain desired search results.

### CROSS REFERENCE TO RELATED APPLICATIONS

This application claims the benefit of U.S. Provisional Patent Application Ser. No. 62/197,440, filed on Jul. 27, 2015, entitled “COMMUNICATION BASED SEARCHING METHOD AND APPARATUS,” which is hereby incorporated by reference in its entirety.

### BACKGROUND

1. Field of the Invention

The present invention relates to a method and apparatus for allowing a user to interface with software for obtaining real estate or home information. More particularly, the present invention relates to a mobile or other software application for allowing a user to communicate therewith, such communication interpreted by the mobile or other software application in order to return appropriate responses or information to the user.

2. Description of the Related Art

The home search or real estate market is a large business both in the United States and Worldwide, linking potential customers of a large variety of real estate properties (e.g., single family homes, multi-family homes, apartment homes, condominiums, land, business leases, etc.) with a vast array of information about such properties. Customers typically have one or more criteria they consider important or desired regarding their purchase or lease of real estate, and efficient real estate searching should be capable of allowing the potential customer to easily see or determine which properties match with such criteria and are available for purchase. Although such information about such properties may be obtainable, for example, via the Internet or via direct communication with a real estate agent, there are a number of barriers that make the process less efficient or more difficult for consumers than would be desired.

For example, although potential customers may be able to perform manual searches on the Internet to obtain information regarding school districts, police reports or statistics, nearby fire stations, etc., the customers are responsible for performing this multitude of separate searches and personally attempt to link this information to the potentially large variety of properties that they might have an interest in. In addition, much of this information may be spread out among different websites, with the potential customer being unaware how reliable, up-to-date, or trustworthy such information is, particularly when faced with different search results providing conflicting information. In addition, many real estate properties may not be easily viewable or available at all upon websites or other databases that a potential customer can browse through.

Thus, there is a need for an improved method and/or apparatus for allowing customers to search and/or otherwise locate properties that may be of interest for purchase or lease. In addition, there is also a need for an improved method and/or apparatus that provides information about such properties. Ideally, such a method and/or apparatus would be easy to use, efficient, and provide users with a simple, yet comprehensive, look at properties that match one or more customer criteria.

### SUMMARY

The present invention is related to a method and/or application and/or system for allowing user searches and/or transmittal of information regarding home or other real estate properties to a user. In one embodiment, a method of providing search results for real estate to a user may include providing a software application configured to be executed by a processor of a mobile device, providing a database record associated with first information corresponding to a real estate property and second information corresponding to a geographic region servicing the real estate property, determining, using the processor, a first criteria desired by the user, determining, using the processor, whether the database record matches with the first criteria desired by the user, and displaying at least some of the information associated with the database record.

In another embodiment, a mobile application providing real estate search result functionality for a user may include a database record associated with first information corresponding to a real estate property and second information corresponding to a geographic region servicing the real estate property and computer-readable instructions configured to be executed by a processor of a mobile device, the instructions configured to: determine, using the processor, a first criteria desired by the user, determine, using the processor, whether the database record matches with the first criteria desired by the user, and display at least some of the information associated with the database record.

In another embodiment, a method of providing search results for real estate to a user may include storing real estate data corresponding to a real estate property, creating a user account corresponding to the user, storing preference data for the user, the preference data associated with the user account and configured to automatically update based upon user searches, providing a software application configured to be executed by a processor, determining, using the processor, a first criteria desired by the user, determining whether at least some of the real estate data matches with the first criteria, determining, whether at least some of the real estate data matches with the preference data, and providing, using the processor, at least some of the real estate data to the user.

In still another embodiment, a method of providing search results for real estate to a user may include storing data corresponding to a real estate property, storing preference data for the user, receiving an input request from the user, updating the preference data for the user based upon the input request, determining whether a first part of the real estate data matches with the input request, determining whether a second part of the real estate data matches with the preference data, and displaying the first part of the real estate data and the second part of the real estate data to the user.

In yet another embodiment, a system having real estate searching functionality for a user may include a database record having a first field associated with real estate property data and second field associated with geographic region data and a processor configured to access the database record. The processor may be configured to receive an input request, store at least some information associated with the input request as a preference information for the user, determine whether the input request matches with the first field of the database record, determine whether the input request matches with the second field of the database record, and transmit at least some of the information of the first field and the second field.

### BRIEF DESCRIPTION OF THE DRAWINGS

The features, objects, and advantages of the present invention will become more apparent from the detailed description set forth below when taken in conjunction with the drawings, wherein:

FIG. 1 shows a block diagram of a system implementing a real estate search or information provision software application according to one embodiment of the present invention;

FIG. 2A shows a display of a system implementing a real estate search or information provision software application having voice recognition according to one embodiment of the present invention;

FIG. 2B shows a display of a system implementing a real estate search or information provision software application having text recognition according to one embodiment of the present invention;

FIG. 3 shows a block diagram of a database ranking for a system implementing a real estate search or information provision software application according to one embodiment of the present invention; and

FIG. 4 shows display of a system implementing a real estate search or information provision software application having image recognition capabilities according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

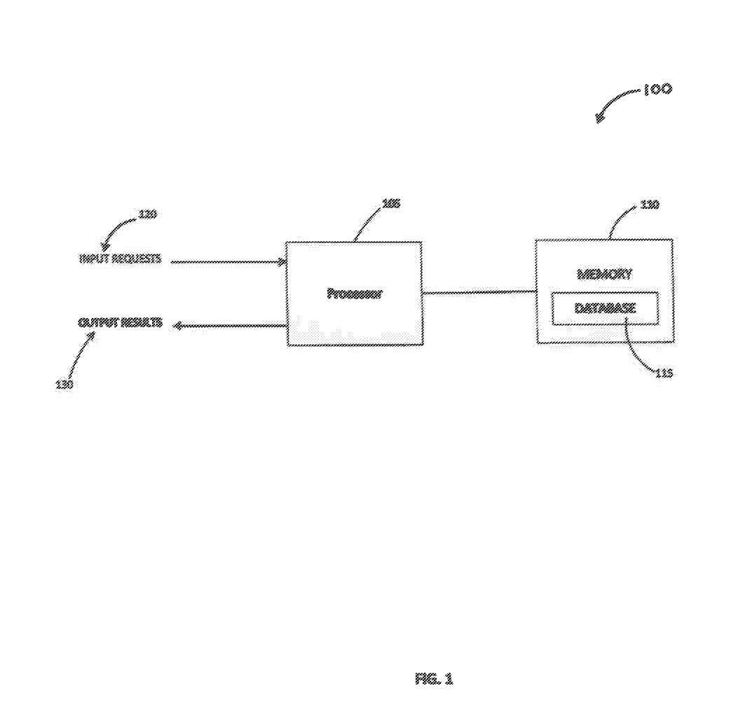

Turning first to FIG. 1, a block diagram of a system 100 is shown that may implement a home or real estate search and/or information provision software application. For example, the software application may include features that are the same as or similar to those discussed herein. The system 100 includes a processor 105 connected with a memory 110, the memory 110 configured to store data (e.g., either structured and/or unstructured data). Such structured and/or unstructured may then be searched, referenced, or otherwise accessed in response to input requests (e.g., either from user-based inquiries or other, inquiries that have been determined as being potentially relevant to a user search, as discussed in more detail throughout. The processor is configured to interface or otherwise communicate with the memory, for example, via electrical signals propagated along a conductive trace or wire. In an alternative embodiment, the processor 105 may interface with the memory 110 via a wireless connection. In one embodiment, the memory 110 may include a database 115, a plurality of data or entries capable of being stored in the database 115 of the memory 110. For example, as discussed in greater detail herein, the memory 110 and/or the database 115 may store information about real estate properties that may be accessed and/or retrieved and/or sent to a user based upon user requests and/or criteria.

As discussed in greater detail herein, the processor 105 may be tasked with executing software or other logical instructions in order for the service request application to function as desired. Input requests 120 may be received by the processor 105 (e.g., via signals transmitted from a user at a remote system or device, such as a handheld (or mobile) device, such as a smartphone, tablet, wearables like a watch, or any other type of device capable of communicating with a processor, to the processor 105 via a network or Internet connection). In an alternative embodiment, the input requests 120 may be received by the processor via a user input device that is not at a geographically remote location (e.g., via a connected keyboard, mouse, etc. at a local computer terminal). After performing tasks or instructions based upon the user input requests 120, for example, looking up information or data stored in the memory 110, the processor 105 may output results 130 back to the user that are based upon the input requests 120. The system 100 may be configured for cognitive learning in order to more successfully adapt or engage with user requests for information. For example, the system 100 may, in certain embodiments, be configured to utilize past inquiries from a particular user or from a plurality of users, to make determinations as to the type and/or relevance of information that may be of interest to the same user or other users in future searches. In certain embodiments, data may be stored in an unstructured format, as previously mentioned, such unstructured data accessed in response to input requests from the processor, for example, utilizing the cognitive learning capabilities of the system 100. In an alternative embodiment, any of a variety of systems capable of receiving input data, accessing stored data, processing software instructions, and/or transmitting output data may be utilized.

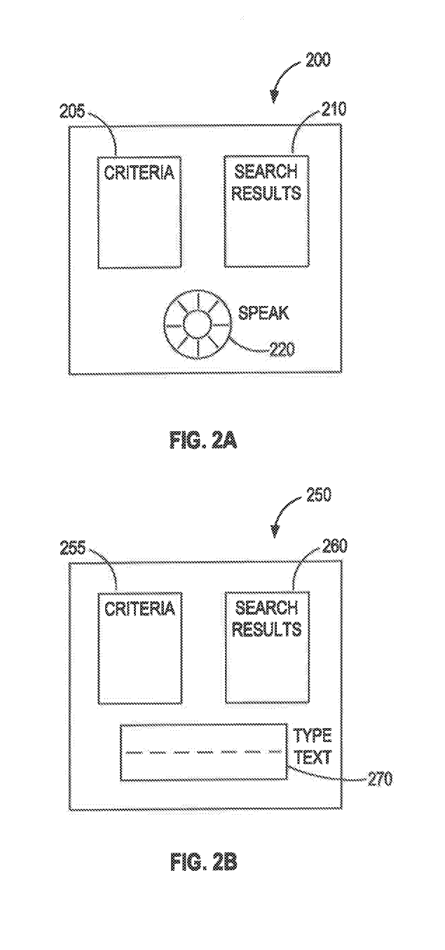

FIGS. 2A and 2B show two possible display screens (200, 250) of a software application for allowing a user to communicate with the software application and obtain relevant results regarding home or real estate properties. One problem with conventional real estate searching for consumers is the lack of consolidated and/or easy to obtain information about potential properties of interest. For example, a potential buyer of a new home may not be decided about the particular city they wish to move. Perhaps the buyer knows of the general geographic region that is of interest, but a plurality of cities or municipalities exist within that general geographic region and the buyer may consider all or some of them as containing relevant home properties that he/she would consider. Utilizing a conventional home or real estate searching method, the user may be required to enter a particular city or zip code and then other information regarding their desired home characteristics (e.g., number of bedrooms, size of garage, square footage, etc.) in one or more selection boxes. However, a variety of other information may be important, or possibly even more important, to potential customers that are not available via conventional home or real estate searches, such as police statistics, municipality features or data, school data, etc. Moreover, the conventional systems requirement that a user manually step through a series of discrete criteria selections may be burdensome and annoying to customers.

The display screen 200 of the software application shown in FIG. 2A may help addresses one or more of these issues by allowing a user to communicate via voice with the software application about a variety of criteria relevant to their home or real estate searching interests, including one or more of those features (and/or additional features, data, or statistics) mentioned above that have not conventionally been compiled and easily available for search. As illustrated, the display screen 200 includes a user interface element 220 (e.g., a button or graphic that may be activated, such as through manual interaction therewith by the user or automatically when the user begins speaking) that listens and/or records the spoken words of the user. For example, the user may describe a plurality of criteria that is of interest, such as “Show me single family homes that are larger than two thousand square feet, have 3 bedrooms, two bathrooms, and are located within one mile of a park having a playground.” In another example, the user may state “Show me apartments that are larger than one thousand square feet within ten miles of zip code nine-two-six-four-eight and rank the results according to price (e.g., or other desired data) from lowest to highest.”

As previously discussed, for example in FIG. 1, a user may interact with the display screen 200 of the software application via an on-going conversation and the system may respond to such inquiries by keeping track of the user's preferences (e.g., either the immediate preferences of the current search state or remembering user preferences from prior searches (e.g., a pervasive user profile or account) by the user (or other users) and using such preferences to make determinations as to the type of information or results to be pulled from memory (e.g., unstructured data) that are of most interest. In certain embodiments, data or results may be suggested to a user, even if not specifically requested by the user, based upon the profile or account of the user, the profiles or accounts of other users (e.g., similar searches performed by others), and/or any of a variety of other determinations made by the system. Priority of information may either be performed automatically by the software application (e.g., via the above-described preferences) and/or may be set by the user (e.g., the user may state that properties above a certain square footage is the most important data regarding the property search).

Upon listening and/or recording the user's commands, the software application would recognize and/or analyze the user's communication (e.g., using a processor, such as processor 105 described for FIG. 1) and determine home or real estate results that match one, more than one, and/or all of the user's spoken criteria (e.g., using a memory or database, such as memory 110 and/or database 115 described for FIG. 1). This determination may use a memory that is local to the device running the software application and/or may use memory that is located remotely, such as via a connection over the Internet. The memory may contain various data about the real estate properties themselves (e.g., building info) and may also contain various data about the geographic area corresponding to the real estate properties themselves (e.g., police or municipality data or statistics, school district data, etc.). In certain embodiments, various memory in a plurality of systems (e.g., either local to one another or located remotely from one another) may be interacted with in response to a user's spoken requests. In this fashion, results based on one or more of the user's criteria can determined and shown or otherwise communicated to the user.

For example, as shown, a first area 205 of the display screen 200 may be configured to list or otherwise display criteria that is recognized or otherwise determined from the user's spoken requests. This may provide visual feedback to the user that the software application has appropriately recognized the command. In certain embodiments, subsequent spoken commands from the user may be interpreted to modify (e.g., add new criteria, edit existing criteria, and/or delete criteria) from the current user request. Correspondingly, upon determination of relevant results based upon this criteria (e.g., as described above) a second area 210 of the display screen 200 may list or other display results that match one or more of the user's criteria.

The results in the second area 210 may be ranked and/or displayed according to a predetermined characteristic or property (e.g., most relevant, closest distance) that is determined by the software application, or may be ranked and/or displayed according to a user-defined characteristic or property (e.g., police or municipality data). For example, this may allow a user to view results that are not limited to only a particular city or zip code, but allows a user to search for potential real estate in a larger geographic area according to other data, such as police or municipality data or educational standards which may be of greater importance to the user versus being near a particular geographic coordinate. Thus, such a contextual-based communication search would eliminate a user's need to seek out information on the Internet or elsewhere and could provide meaningful results to the user that the user may feel is more trustworthy or standardized because a single software application has already compiled, stored, and/or vetted the information contained therein that is provided.

FIG. 2B shows a display screen 250 of a software application that may include features that are the same as or similar to those previously discussed, for example, in FIG. 2A. The software application of FIG. 2B may also allow a user to communicate with the software application and obtain meaningful results based on a contextual or other recognition of the user's commands, requests, and/or input. However, while FIG. 2A utilized voice-based communication, FIG. 2B utilizes text-based communication. Thus, if a user is in a situation where spoken words may be inappropriate or undesirable, such as in a public location, the user may type their desired search into a user interface element 270 (e.g., a text box, a drop-down box, or any other type of user interfaceable element for accepting user input). The same as or similar to the discussion above for FIG. 2A, the software application would interpret this text to determine criteria, display such criteria in a first area 255 of the display screen 250, and determine relevant results which may be ranked and/or otherwise displayed in a second area 260 of the display screen 250.

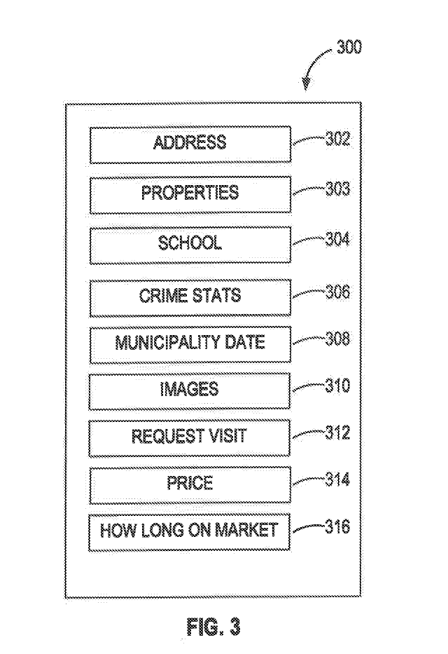

Next, FIG. 3 shows a block diagram of a database record 300 for use in a system implementing a real estate search or information provision software application. The database record, system, and/or software application may include features that are the same as or similar to those previously discussed. Moreover, although the database record 300 shows, for illustrative purposes, a number of potential information varieties or categories, they may not be all inclusive and a variety of alternative and/or additional information may be included in alternative embodiments (e.g., animal restrictions, etc.). For example, a variety of information on both home or properties and/or their surrounding geographic regions may be stored and/or related within a memory, database, and/or other storage system. This information may then be analyzed, searched, and/or retrieved based upon input received from a user in order to find appropriate results for communication back to the user.

For example, the database record 300 may include a plurality of linked fields containing information regarding a home or other real estate address. As illustrated, an address field 302 may include information regarding the address (e.g., street number and/or name, city, state, zip code, geographic coordinate such as latitude/longitude, etc.). A properties field 303 may include additional properties information about the home or other real estate address corresponding to database record 300. For example, this properties field may include number of bedrooms, number of bathrooms, square footage, size of land, number of stories, type of exterior construction, amenities of the home or other real estate address such as swimming pools or laundry rooms, etc. In certain embodiments, the properties field may include information or statistics directly related to the property in question and/or more include information or statistics about the surrounding geographic area, such as nearby gyms, parks, entertainment venues (e.g., museums, movie theaters, concert halls, sporting venues, etc.), public services (e.g., libraries, fire stations, police stations, veterinary clinics, hospitals, etc.) schools, or any of a variety of possible items that may be of interest to potential renters or buyers of a property. In certain embodiments, multiple properties fields 303 may be used, for example, one for each type of property. This may allow for easier searching of multiple database records for a system based upon particular criteria.

The database record 300 may also include an asking price field 314 and/or a market field 316 that indicates how much time the particular home or real estate address corresponding to the database record 300 has been on the market. In addition to these properties, the database record 300 may also contain one or more fields having information, data, and/or statistics on geographic areas that relate to the home or other real estate address. For example, a school or education field 304 may contain information regarding the school district or educational programs offered in the geographic region servicing the home or real estate address. A crime field 306 may contain information regarding crime activity in the geographic region servicing the home or real estate address (e.g., based upon police reports or statistics). Likewise, a municipality field 308 may contain information regarding municipality data and/or features (e.g., nearby places of interest such as parks, beaches, public pools, etc.) for the geographic region servicing the home or real estate address. In certain embodiments, for example, the school or education field 304, crime field 306, and/or municipality field 308 may have such information stored elsewhere in memory and these fields merely relate or link the database record 300 to the information stored at those elsewhere memory locations rather than storing such information directly in the education field 304, crime field 306, and/or municipality field 308.

Additional fields may also have information contained and/or linked therewith for the database record 300. For example, and as illustrated, an images 310 field may contain or link to images, videos, animations, or other media, etc. that correspond to the home or real estate address associated with the database record 300. Moreover, an open house field 312 may indicate whether the home or real estate address associated with the database record 300 has open house showings available and/or when the home is available for such a showing.

Utilizing one or more of these stored database records, for example in memory 110 and/or database 115 as discussed for FIG. 1, input requests from a user that specify one or more criteria of interest may be matched with one or more fields of one or more database records in order to determine appropriate results to output to the user. In certain embodiments, these results may be output and/or displayed to the user according to a predetermined order or ranking (e.g., system defined and/or user-defined) in order to make the browsing or searching process convenient for the user.

For example, fields of a database record may include “home-based” information (e.g., number of bedrooms, square footage of home, number of bathrooms, etc.) and/or may include “environment-based” information (school data for a zip code or area containing the home address, police data for a zip code or area containing the home address, nearby activities such as parks, public pools, etc.). In an alternative embodiment, any of a variety of information types may be included. Based upon input from a user (e.g., multiple criteria of interest, for example, both home-based and environment-based criteria), a system may determine a ranking of priority for the supplied criteria to guide the most relevant or appropriate search or output results. For example, if a user's input request is “find me houses in an area near a fire or police station, preferably with two bedrooms,” the system may place a higher rank or priority upon the criteria requesting such geographic proximity to a fire or police station than upon the criteria requesting 2 bedrooms.

Thus, in certain embodiments, the system may prioritize criteria and/or fields as between those within the same type of information (e.g., multiple home-based criteria will be ranked among themselves, multiple environment-based criteria will be ranked among themselves, etc.) and/or as between those within different types of information (e.g., prioritize environment-based criteria over all home-based criteria). In certain embodiments, ranking and/or prioritization may occur in two steps (e.g., rank multiple home-based criteria among themselves, rank multiple environment-based criteria among themselves, and then subsequently rank the home-based criteria with the environment-based criteria). In this fashion, the system may be configured to display (e.g., in ranked order) output results that are relevant and response to any of a variety of user preferences and/or requests.

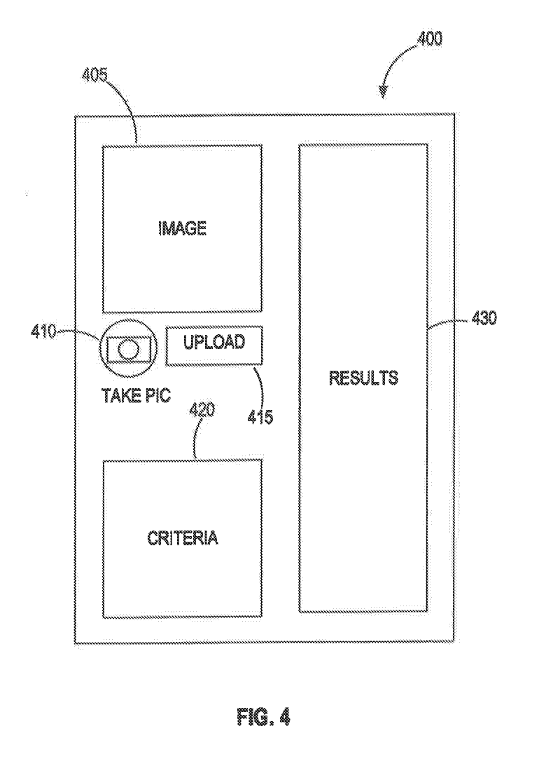

Lastly, FIG. 4 shows display screen 400 of a system implementing a real estate search or information provision software application having image recognition capabilities. The display screen, system, and/or software application may include features that are the same as or similar to those previously discussed. Oftentimes, potential home or real estate buyers have a look and/or feel for a new home or residence that is viewed as more desirable to them over others. Conventional home or real estate searches either cannot incorporate such criteria into consideration and/or have to approximate what the potential buyer may like by asking for generic responses from a user (e.g., Mediterranean Style versus Cottage Style homes). The display screen 400 illustrates image recognition capabilities for the software application that allow for a user to more directly indicate and request results for available real estate, based on photographs or pictures that are desirable.

As shown, a first area 405 is disposed on the display screen for displaying of a picture or photograph that the user desires to find matching results thereto. For example, a user may be driving or traveling around outside and see a particular home or residence that they find particularly attractive or desirable. The user may interact (e.g., touch or press) on a first user interface element 410 on the display screen 400 that enables the user to take a photograph (e.g., by opening a camera application or function on their mobile device that is running the software application, such as a smart phone or cell phone). In another example, if the user does not wish to take a current photograph for such analysis, the user may interact (e.g., touch or press) on a second user interface element 415 on the display screen 400 that enables the user to choose a pre-existing photograph or picture.

Upon capturing the home or residence using the camera, or otherwise selecting or choosing an appropriate picture or photograph, this image is shown in the first area 405 and analyzed, either using local algorithms stored as part of the software application, or by uploading/transmitting the photograph to a remote system that recognizes and/or analyses the photograph for particular features. This image recognition is used to determine those features of the photo that may be matched to other homes or residences that exhibit similar looks or styles such that a user can find other homes and/or real estate properties that contain the look or style that they desire. In certain embodiments, and as shown, a second area 420 of the display screen 400 may contain additional criteria that the user can input or determine (e.g., by speaking, typing, or otherwise interfacing with the software application, such as via methods that are the same as or similar to those previously discussed. A third area 430 of the display screen may then be used to display appropriate search results, based upon the image recognition discussed and/or one or more of the criteria input by the user.

The previously discussed mobile or software applications may include features and/or operation different from those stated in the exemplary embodiments detailed above. Features and/or operation in one embodiment may also or additionally be included with features and/or operation of a separately discussed embodiment. Moreover, features may be added, removed, or executed with different operative flow from the exemplary embodiments detailed above. For example, in one embodiment, the software application may be configured to allow a user to register (e.g., create an account) therewith. Having such an account, various user properties and/or preference data may be stored and/or linked therewith, such that a user may store commonly-used search criteria or other information. In one example, a user having a user account may be configured to receive notifications (e.g., pop-up notifications on a device running the software application, emails, text messages, etc.) based on stored criteria and/or past searches, such as when a new home or real estate property comes on the market that contains one or more criteria that matches a desired feature for the user.

In addition, in certain embodiments, usage of the software application may be tracked, stored, and/or analyzed to gather and/or provide market data. For example, based upon tracking of one or more user criteria that is searched using the software application, market data or statistics may be generated (e.g., “90% of all users search for a property that is greater than 2000 square feet within a given zip code”). Such market data can be useful for builders or other real estate planners to know what criteria customers (e.g., customers looking within a particular geographic region) tend to desire with more regularity, allowing for new homes or renovations to be undertaken with such criteria in mind.

In still other embodiments, additional or alternative features may be included, such as features that utilize other aspects of the user device that is running the software application. For example, if the software application is being executed upon a mobile device, such as a smart phone, that contains geo-locating capabilities (e.g., GPS), features of the software application may allow for result determination based upon a particular present location for the user (e.g., “Tell me homes that are available within 5 miles of my current location,” “Tell me police report data or statistics for my current location,” etc.

In addition, certain embodiments may utilize and/or recognize any of a variety of criteria that a user may supply information thereabout. As one example, a user may be able to specify whether he/she has been pre-qualified for a purchase and/or supply other information relating to a pre-qualification and/or loan amount for which he/she has been approved. If applicable and/or supplied, this information may be used to determine and/or filter the appropriate search results displayed or otherwise output to the user. In certain embodiments, if a user has not been pre-approved and/or qualified for a loan, the software application may provide additional functionality and/or connections (e.g., connecting a user with a financial institution) in order to pre-approve or prequalify the user for a certain funding amount. This amount may then be used to determine or filter the appropriate search results shown to the user (e.g., properties outside of the pre-approval price range would not be shown). Thus, the software application may enable a user to not only search for homes, but also facilitate the user's acquisition of appropriate funding needed for purchase, eliminating one step that the user would otherwise have to undertake separately when shopping for real estate.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. A method of providing search results for real estate to a user, comprising:
storing real estate data corresponding to a real estate property;
creating a user account corresponding to the user;
storing preference data for the user, the preference data associated with the user account and configured to automatically update based upon user searches;
providing a software application configured to be executed by a processor;
determining, using the processor, a first criteria desired by the user;
determining whether at least some of the real estate data matches with the first criteria;
determining, whether at least some of the real estate data matches with the preference data; and
providing, using the processor, at least some of the real estate data to the user.

2. The method of claim 1 wherein any of the real estate data, the user account, or the preference data is stored in a memory remote from the processor.

3. The method of claim 1 wherein the real estate data is unstructured data.

4. The method of claim 3 wherein the real estate data is stored as a database record with a plurality of linked fields.

5. The method of claim 1 wherein the real estate data includes information relating to entertainment venues within a predetermined geographic region of the real estate property.

6. The method of claim 1 wherein the second data includes information relating to public services within a predetermined geographic region of the real estate property.

7. The method of claim 1 wherein the providing of at least some of the real estate data to the user includes displaying at least some of the real estate data on a screen.

8. The method of claim 1 wherein the determining the first criteria desired by the user includes recognition of words spoken by the user.

9. The method of claim 1 wherein the determining the first criteria desired by the user includes contextual-based recognition of words spoken or typed by the user.

10. A method of providing search results for real estate to a user, comprising:
storing data corresponding to a real estate property;
storing preference data for the user;
receiving an input request from the user;
updating the preference data for the user based upon the input request;
determining whether a first part of the real estate data matches with the input request;
determining whether a second part of the real estate data matches with the preference data; and
displaying the first part of the real estate data and the second part of the real estate data to the user.

11. The method of claim 10 wherein the second part of the real estate data did not explicitly match with the input request from the user.

12. The method of claim 10 further comprising:
storing an account associated with the user; and
transmitting a notification to the user associated with the account.

13. The method of claim 12 wherein the notification is an email message, a text message, or a pop-up message.

14. The method of claim 10 wherein the data corresponding to a real estate property is a database record having at least one linked field.

15. The method of claim 14 wherein the database record has a first linked field containing a geographic location for a real estate property and a second linked field containing information regarding police statistics associated with the geographic location.

16. The method of claim 14 wherein the database record has a first linked field containing a geographic location for a real estate property and a second linked field containing information regarding public services or entertainment venues within a vicinity of the geographic location.

17. A system having real estate searching functionality for a user comprising:
a database record having a first field associated with real estate property data and second field associated with geographic region data; and
a processor configured to access the database record, the processor configured to:
receive an input request,
store at least some information associated with the input request as a preference information for the user,
determine whether the input request matches with the first field of the database record,
determine whether the input request matches with the second field of the database record, and
transmit at least some of the information of the first field and the second field.

18. The system of claim 17 wherein the processor is further configured to determine a ranking of the at least some of the information of the first field or the second field.

19. The system of claim 18 wherein the ranking is based on the preference information from the user.

20. The system of claim 19 wherein the preference information includes information stored from a plurality of previous input requests from the user.
